(19) United States
(12) Patent Application Publication
(10) Pub. No.: US 2019/0099037 A1
(43) Pub. Date: Apr. 4, 2019

(54) COFFEE PERCOLATOR WITH SMART TECHNOLOGY CONTROLS

(71) Applicant: Kyle Hansen, Castle Rock, CO (US)

(72) Inventor: Kyle Hansen, Castle Rock, CO (US)

(21) Appl. No.: 15/723,013

(22) Filed: Oct. 2, 2017

(51) Int. Cl. A47J 31/00; A47J 31/06; A47J 31/44

(52) U.S. Cl. CPC A47J 31/005; A47J 31/4403; A47J 31/06

(57) ABSTRACT

The invention is a novel programmable percolator for coffee beverages with smart programming to control brew time start, brew time stop, temperature, and an audible signal when the brewing cycle is complete, as well as entire shut down of the percolator at user specified time intervals. The percolator is programmed and controlled via a smart chip which may also receive wireless commands for percolator operation. The base for the percolator also creates a warming plate which can be set for timed intervals to keep the brewed coffee beverage warm.

### FIELD

The present invention relates to an improved coffee percolator with electronic controls for programming options via wired or wireless modes including features such as brew start times, shut off, warming, and a tone signal when brewing is complete. A percolator can be defined as a pot that is used for brewing coffee by repeatedly cycling near-boiling water through coffee grounds until a desirable coffee beverage strength is achieved. The main advantage of brewing coffee using percolators is that they normally expose the coffee ground to temperatures that are higher compared to other brewing methods. Furthermore, they recirculate coffee that is already brewed through the beans.

### PRIOR ART

There are many iterations of coffee percolators known in the art. Some have programmable features, and some do not. However, the prior art does not disclose a coffee percolator with brewing shut off, a controlled warming plate, or a tone that notifies the user that the brewing process is complete. The inventive percolator can also be controlled via a wi-fi or smart phone app. However, the majority of percolators are manual and need constant checking to get the perfect brew. It is not recommended for brewed coffee to be left on a high heat for long, since this will make the coffee bitter to the taste buds.

In U.S. Pat. No. 4,993,315 (Huber et al), the coffee percolator is disclosed as having a brewing chamber wherein at least one of the boundary wall surfaces of the brewing chamber is adjustable transversely of the direction of flow of the hot water through the coffee powder so that the thickness of the coffee powder bed in the direction of flow may be kept substantially constant for the coffee charges of varying size. The coffee percolator may include a brewing sieve having a support sieve with openings of a size exceeding the dimensions of the ground coffee particles and a fine sieve supported on the side of said support sieve facing towards the brewing chamber and having openings of a size smaller than the dimensions of the ground coffee particles. This patent does not provide for electronic or wireless controls among other differences between Huber and the present Percolator. As said supra, the majority of percolators are manual and need constant checking to get the perfect brew. It is not recommended for brewed coffee to be left on a high heat for long, since this will make the coffee bitter to the taste buds.

In U.S. Pat. No. 4,724,079 (Princz et al.), a coffee percolator is claimed as having a coffee meal supply container mounted at an upper portion thereof, in which heating of the coffee meal supply by the heat of the coffee percolator and the resultant loss of volatile aroma substances are avoided. This is accomplished by providing a cooling system effective to cool the bottom of the supply container. In a preferred embodiment, the supply container is cooled by means of air aspirated by a fan through an air flow path extending along the bottom of the supply container and subsequently returned to the environmental atmosphere. Princz does not disclose timing features either wired or wireless. Further, it requires a fan system for cooling percolated coffee. This teaches away from the present Percolator in that the coffee is meant to be kept warm by a warming plate or method.

U.S. Pat. No. 4,703,686 is described is a coffee percolator for dispensing individual charges of freshly brewed coffee, which may also be employed, however, for satisfying a temporarily occurring increased demand. To this purpose the percolator is provided with a second outlet for dispensing the coffee into a storage container. In a preferred embodiment, two separate switching means are provided for actuation by the user for dispensing the coffee directly into a serving receptacle or into the storage container. This permits charges of different size to be preselected, so that a greater amount of coffee can be brewed for filling the storage container than would be required for filling a serving receptacle. The storage container is portable and provided with its own outlet, so that it can readily be carried to the site of use. There is no such transfer and storage system in the inventive Percolator.

What becomes apparent after careful searching and review, is that the prior art percolators do not have means, methods or features that encompass what Applicant's novel Percolator discloses. And prior art has means, methods or features which are not claimed in Applicant's Percolator Application. Attempts to combine the prior art would be unsuccessful since many of the prior art features either teach away from one another, or would not operate as the inventor intended. Applicant's Percolator is novel over the prior art both from a § 102 and § 103 perspective.

### BRIEF DESCRIPTION OF THE INVENTION

The present inventive coffee percolator and pod system encompass all the features that drip coffee makers or plastic cup single brew type coffeemakers have, as well as features the aforementioned do not. There has not been the technological attention paid to percolating brewers as with other types, yet many coffee connoisseurs prefer a percolated cup.

### BACKGROUND OF THE INVENTION

The invention most closely corresponds with USPTO Class 99/219 wherein Class 99 relates to percolators animal husbandry and sub-class includes electrically heated percolators.

In its simplest form, the invention relates to a novel coffee percolator which adds features not presently available in the art for coffee percolators on the market.

### THE INVENTION

### Summary, Objects and Advantages

It is well known that coffee is a must for many consumers. Methods of making and serving coffee has turned into a multimillion dollar industry. Coffee shops are located one most city street corners, and each chain or individual shop has methods of making “boutique” coffee. Baristas are now respected as artisans in many cases. People are adamant that their coffee is brewed the way they choose.

Coffee shops can charge fairly hefty prices for crafting a simple cup of coffee to creating a foamy delight such as a latte. Many consumers are willing to pay for these caffeine laden treats. However, there are many who prefer to brew their own coffee at home, and not endure the hassle of lines or mistakenly made drinks. These consumers have several home-brew options.

Home brew enthusiasts have various options for making coffee such as a drip maker, single cup pod-type brewers, or brewers that grind coffee beans and make the coffee. Many of these coffee makers also offer timing and warming features. Lost in the art, however, is the percolator. There are plenty of coffee connoisseurs who prefer percolated coffee, but have fairly antiquated options for the percolators themselves.

The inventive percolator combines all of the desired modern features a drip or pod-type brewer may offer, but concentrated in one percolator unit. The inventive percolator provides timed brew, timed heating elements, notification of brew cycle, and even a “smart” interface app for the consumer to operate the percolator from. The warmth source in the base or warming plate of the percolator warms the water in the carafe. Water at the base of the percolator gets hot first and begins to bubble. The bubbling makes rises rise and drive water up a vertical tube in the center of the carafe, and then out the highest point of the vertical tube. From the highest point of the tube, the water streams out and over the top of the coffee percolator. Holes in the tube basket disseminate the water over the highest point of the coffee grounds. The water then leaks through the coffee grounds then through the base of the coffee basket. From the base of the coffee percolator, the water drops onto the colder water at the highest point of the base percolator, driving water up the tube. This entire cycle rehashes consistently

### BRIEF DESCRIPTION OF THE DRAWINGS

The invention is described in further detail by reference to eleven (11) drawings sufficient in detail to describe the invention in which:

FIG. 1 shows a base portion with controls;

FIG. 2 is a second perspective of a base with controls;

FIG. 3 is another embodiment of the base piece with controls;

FIG. 4 is a full pot view with controls on the pot;

FIG. 5 is another embodiment of the pot with controls on base;

FIG. 6 is a reverse side of FIG. 5;

FIG. 7 is a cut away perspective of the percolator;

FIG. 8 is an embodiment of the percolator with controls on handle and water level readout, and the percolator lid;

FIG. 9 is a cut away perspective of FIG. 8;

FIG. 10 is a percolator embodiment with a domed top; and

FIG. 11 is a cutaway perspective of FIG. 10.

### DETAILED DESCRIPTION, INCLUDING BEST MODES OF CARRYING OUT THE INVENTION

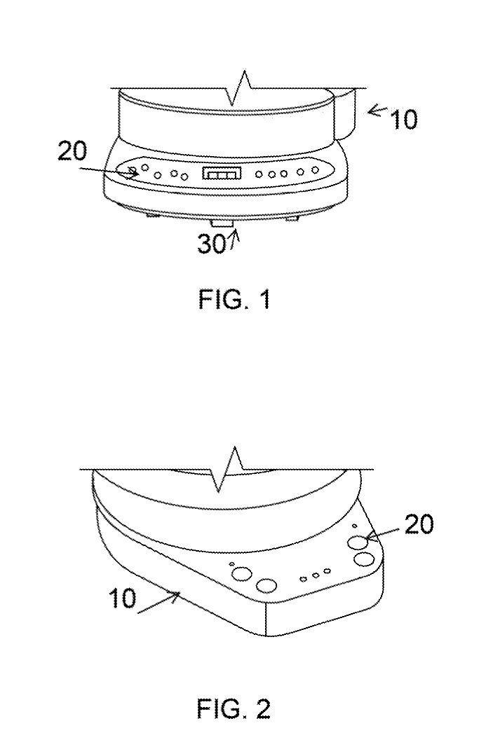

FIG. 1 comprises the base piece in general 10. Controls 20 located in the base may include, but are not limited to, modes for brew time start, brew time stop, temperature, and an audible signal when the brewing cycle is complete. Control features can include receiving a wireless signal from a mobile phone app. Non-skid feet 30 are located under the base piece so the percolator remains in place.

FIG. 2 again show a base piece 10. The embodiment in this Figure shows another layout for the electronic controls 20. As with the embodiment of FIG. 1, controls 20 located in the base may include, but are not limited to, modes for brew time start, brew time stop, temperature, and an audible signal when the brewing cycle is complete. Control features can include receiving a wireless signal from a mobile phone app.

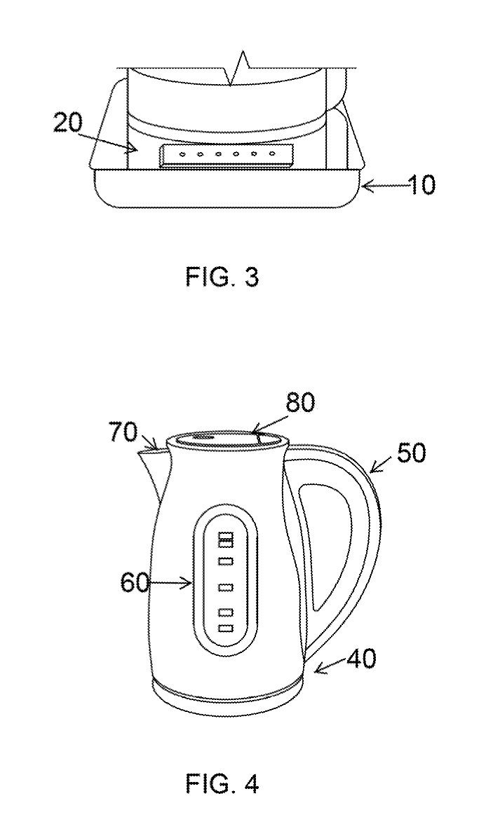

FIG. 3 shows yet another embodiment of the base piece 10 wherein controls 20 are simply in a different visual configuration. As with FIGS. 1 and 2, controls 20 located in the base may include, but are not limited to, modes for brew time start, brew time stop, temperature and an audible signal when the brewing cycle is complete. Control features can include receiving a wireless signal from a mobile phone app.

FIG. 4 is a full view of the percolator pot 40. In this illustration, a handle 50 is connected to the pot for grasping and pouring brewed coffee. In this embodiment the controls 60 can be located on the percolator pot itself, and would include the features of FIGS. 1 through 3 wherein controls 60 located on the percolator pot may include, but are not limited to, modes for brew time start, brew time stop, temperature, and an audible signal when the brewing cycle is complete. Control features can include receiving a wireless signal from a mobile phone app. A pour spout 70 is located at the top of the percolator just under the top or lid 80. The lid is removeable for the user to fill with water and place coffee in the top portion of the percolator insert (not shown in this Figure).

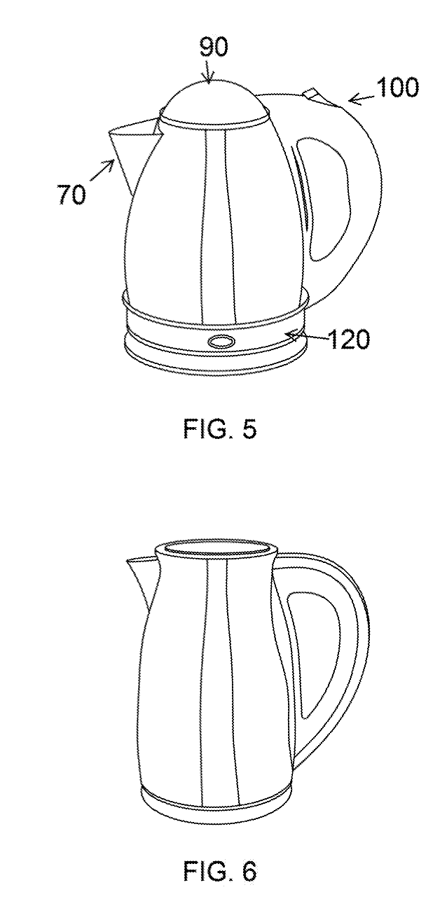

FIG. 5 is an embodiment of the percolator with the controls as in FIG. 4 located on the pot itself (not shown in this view). This embodiment also includes a pour spout 70 as in the previous Figure. A domed lid or top 90 can be transparent so that the percolation action may be viewed by a user, or, as in this Figure be opaque. In this embodiment, a tab 100 on the handle places pressure on the domed top so that the top can be opened. In this embodiment, the base 10 may have some form of simple controls 110 such as a power switch or simply an indicator light.

FIG. 6 is simply the back side of the percolator in FIG. 5.

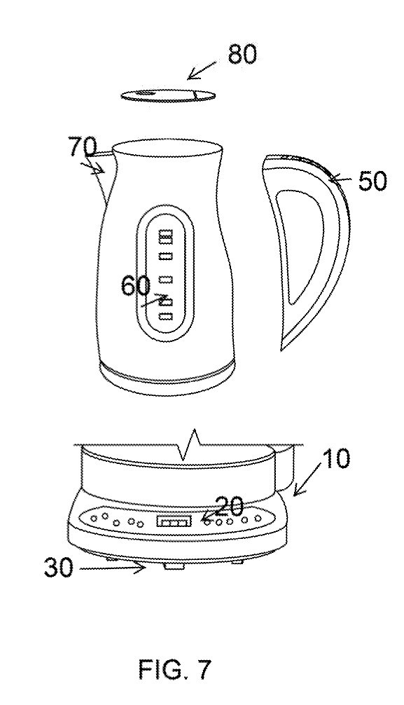

FIG. 7 is a cut-away perspective of the percolator with a handle 50 and again a flat top or lid 80 is an example of this embodiment wherein the top or lid may be transparent or opaque. A pour spout 70 is again shown on the percolator pot, the lip of the spout being arched for optimum pouring accuracy. Again controls 60 are located on the body of the pot itself, and are relatable to the controls on the pot base 10 to effect signal communication for operation of both sets of controls 60 and 20. Non-skid feet 30 are again shown on the base piece 10.

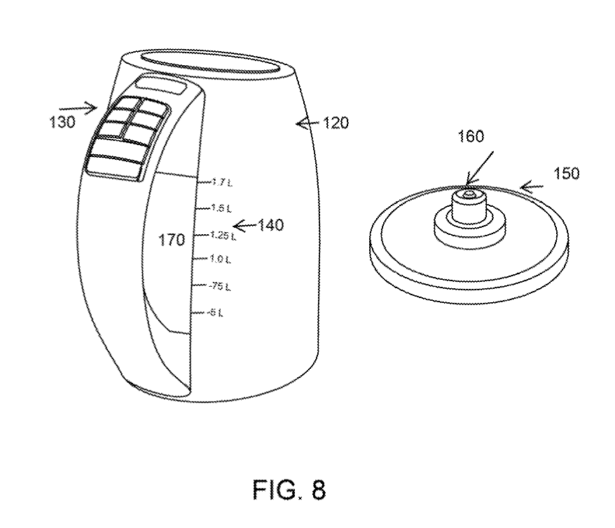

FIG. 8 is another embodiment of the percolator body or carafe as they may be also known. Similar to the carafe in FIG. 5, this embodiment also comprises a body 120, and a handle 50. The controls in this embodiment 130 can reside on the handle of the carafe. The same electronic functions would be offered on this control panel as in those in FIGS. 1-7 in terms of the purpose and function of the buttons thereon. A flat top or lid in this embodiment 150 will allow users to view the percolation action via a transparent piece on top of the lid 160. Further to FIG. 8, this embodiment of the percolator also comprises a water level indicator 140 and a transparent section of the carafe for visible water levels 170.

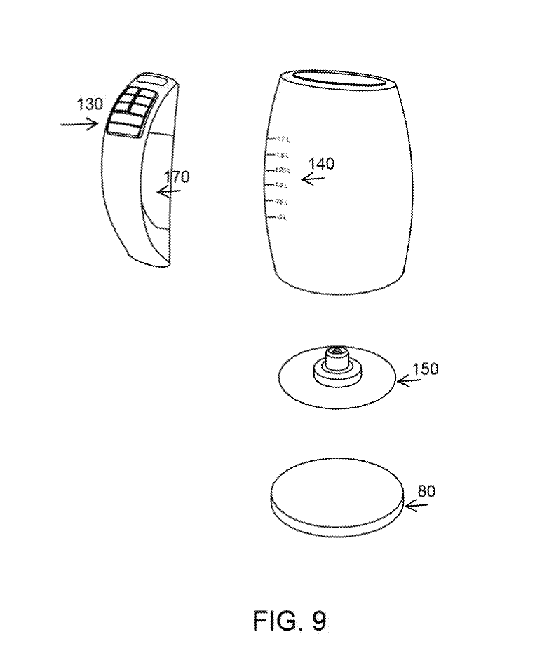

FIG. 9 is a breakaway perspective of the percolator of FIG. 8. Again, the controls are located on the handle of the carafe 130. Also in this Figure a water level indicator 140 and a transparent section of the carafe for visible water levels 170. In this embodiment a warming plate base 180 is shown, and would interact with the controls in the handle wherein a user will program brew times, temperatures etc.

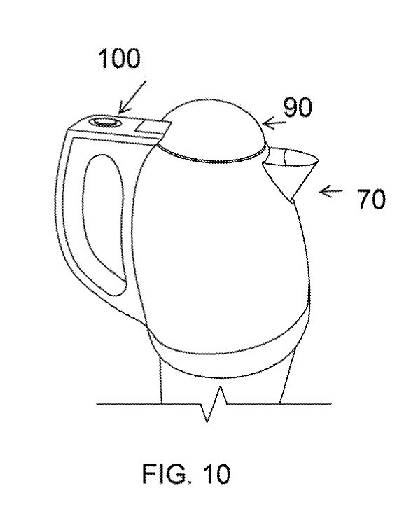

FIG. 10 is an illustration of a similar carafe configuration as in FIG. 5 with a domed top or lid 90. A button on the handle 100 allows or prevents dispensing when pressed. A pour spout 70 is again shown on the percolator pot, the lip of the spout being arched for optimum pouring accuracy.

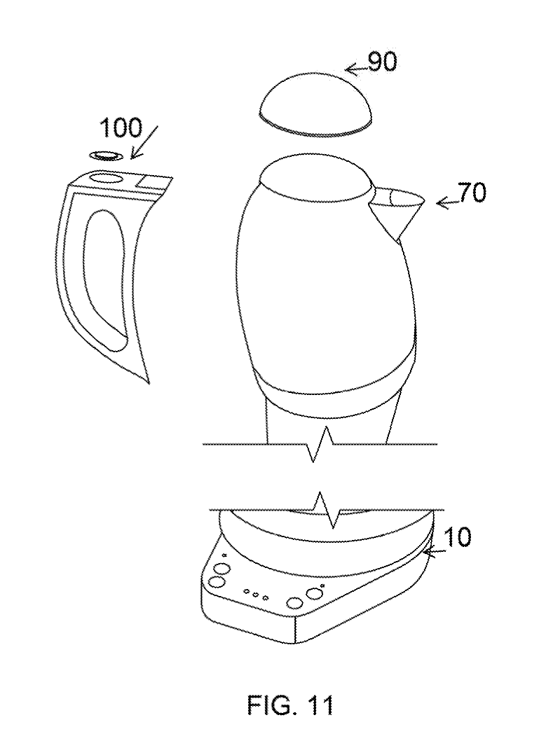

FIG. 11 is a cutaway perspective of the percolator in FIG. 10. Again, a handle 50 is provided for grasping and pouring. A button on the handle 100 allows or prevents pouring when pressed. On this Fig. the domed top or lid is again illustrated 90. A pour spout 70 is again shown on the percolator pot, the lip of the spout being arched for optimum pouring accuracy. As with the preceding embodiments, the base piece 20 has electronic controls which may include, but are not limited to, modes for brew time start, brew time stop, temperature, and an audible signal when the brewing cycle is complete. Control features can include receiving a wireless signal from a mobile phone app.

1) A programmable percolation coffee maker with electronic controls and wireless access comprising:
a) A hollow carafe for receiving water and percolating coffee beverages;
b) A first base piece wherein the base is attachable to the carafe and further contains electronic controls;
c) A warming element located within the base piece for retaining heat in the brewed beverage when the carafe is in contact with the base piece;
d) A handle molded to the exterior of the carafe for grasping and pouring a brewed coffee beverage also comprising a button to allow or prevent dispensing of a brewed coffee beverage;
e) Electronic controls which dictate modes for brew time start, brew time stop, temperature, and an audible signal when the brewing cycle is complete;
f) Wireless receiving capabilities for control of brew time start, brew time stop, temperature, and an audible signal when the brewing cycle is complete; and
g) A microprocessor located in the base piece for high-level data handling wherein the percolator controls can be manipulated wirelessly or wired, and wherein the microprocessor will function as a computing device or a drive-type data holder allowing the various processes in the brew cycle; and
h) A stem and basket piece which resides within the carafe and allows water to seep through the coffee grounds, and wherein the top or lid of the carafe can be connected to the top or lid of the basket piece.

2) A programmable percolation coffee maker with electronic controls and wireless access as in claim 1 wherein the carafe forms a hollow vessel wherein water is cycled through a percolation insert and sieves through ground coffee which also stores and dispense the brewed beverage.

3) A programmable percolation coffee maker with electronic controls and wireless access as in claim 1 wherein the carafe is removeable from the base piece in order to disengage the carafe and pour brewed coffee beverages, and wherein the warming feature in the base is programmable to remain in the on position and keep the brewed coffee beverage warm for a duration of time a user desires.

4) A programmable percolation coffee maker with electronic controls and wireless access as in claim 1 wherein a handle is molded to the exterior of the carafe, and wherein a button atop the handle may be depressed to allow or prevent dispensing the brewed coffee beverage.

5) A programmable percolation coffee maker with electronic controls and wireless access as in claim 1 wherein electronic controls which dictate modes for brew time start, brew time stop, temperature, and an audible signal when the brewing cycle is complete, as well as entire shut down of the percolator at user specified time intervals.

6) A programmable percolation coffee maker with electronic controls and wireless access as in claim 1 wherein wireless receiving capabilities for control of brew time start, brew time stop, temperature, and an audible signal when the brewing cycle is complete; and wherein the programming is achieved via a microprocessor located in the base piece for high-level data handling wherein the percolator controls can be manipulated wirelessly or wired, and wherein the microprocessor will function as a computing device or a drive-type data holder allowing the various processes in the brew cycle and temperature retention times of the brewed beverage.

7) A programmable percolation coffee maker as in claim 1 wherein electronic controls are alternately located in the handle of the percolator and which dictate modes for brew time start, brew time stop, temperature, and an audible signal when the brewing cycle is complete, as well as entire shut down of the percolator at user specified time intervals.

8) A programmable percolation coffee maker as in claim 1 wherein electronic controls are alternately located in the handle of the percolator and dictate modes for brew time start, brew time stop, temperature, and an audible signal when the brewing cycle is complete, as well as entire shut down of the percolator at user specified time intervals.

9) A programmable percolation coffee maker as in claim 1 wherein a transparent section of the carafe can be present with water line measurement indicators adjacent to the transparent section of the carafe for viewing volume of liquid in the carafe.
